(19) United States
(12) Patent Application Publication
(10) Pub. No.: US 2004/0108713 A1
(43) Pub. Date: Jun. 10, 2004

(54) Clamp to anode connection

(76) Inventors: Eliezer Krausz, Tel-Aviv (IL); Avi Chiproot, Kfar-Saba (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/720,523

(22) Filed: Nov. 25, 2003

(30) Foreign Application Priority Data
Dec. 4, 2002 (IL) 153271

(51) Int. Cl. F16L 59/16

(52) U.S. Cl. 285/53; 138/159; 138/155; 285/419

(57) ABSTRACT

The present invention relates to the corrosion protection of a steel pipeline, and to improvements in pipe clamps useful for this purpose. The invention provides a pipe clamp or coupling which makes electric contact with the pipes on which it is assembled and provides a continuous electrical connection, of the pipes. The pipe clamp according to the invention for sealing by means of a metal clamping band to surround the pipe or a pipe coupling for removably holding extremities of a pair of metallic pipes provided with a flexible inner sleeve disposed inside the clamping band; the inner sleeve is attached to the clamping band by means of metallic fasteners, the metallic fasteners being arranged to contact the metallic pipes when the assembly is tightened, to form a continuous electrical connection of the pipes.

### CROSS-REFERENCE TO RELATED APPLICATIONS

This application claims priority of IL Patent Application No. 153271, filed Dec. 4, 2002, which is hereby incorporated by reference.

### FILED AND BACKGROUND OF THE INVENTION

The present invention relates to the corrosion protection of a steel pipeline, and to improvements in pipe clamps useful for this purpose.

More particularly, the invention provides a pipe clamp or coupling which makes electric contact with the pipes on which it is assembled and provides a continuous electrical connection, of the pipes.

Whether steel pipelines are placed underground or above ground, they are subject to corrosive attack. Below ground the steel is attacked by various soil substances, particularly carbonaceous materials and acid wastes. Above ground the typical causes of corrosion are atmospheric moisture in combination with various air pollutants.

A reliable method of resisting corrosion damage is to electrically connect the pipeline to a sacrificial zinc anode, the pipeline thus becoming the cathode. No power source is needed.

Piping, typically underground, may be protected by applying a DC potential of about 0.3V between the steel pipeline and a positive lead to the ground some distance away.

For this a power source is required.

To provide an electric terminal on the pipeline for connection to whatever device is chosen, it is common practice to weld a metal strip thereto. This method requires welding equipment, weakens the pipe, and cannot be used proximate to inflammable materials, liquids or gases.

The following patents relate to cathodic protection of pipelines.

In U.S. Pat. No. 4,692,231 St. Onge discloses a cathodic protection system for metal piping using a sacrificial washer or nut to tighten a pipe joint. A non-sacrificing portion is needed to maintain mechanical connection after anode depletion. The system requires that at least one of the pipes be provided with a flange.

Webster in U.S. Pat. No. 4,863,578 proposes to protect an underground pipeline by means of a sacrificial anode encasing a core electrically connected to the structure. A corrodable link breaks the connection when the anode material is exhausted.

Persson discloses a method in U.S. Pat. No. 5,377,898 for bonding an anode sleeve to a pipe by detonation of an explosive charge within the pipe.

In U.S. Pat. No. 5,415,745 Pultan et al. disclose a method for cathodic protection of an underground pipeline by placing a hollow casing in the ground containing the anode and thereafter establishing an electrical connection.

A more complex method of providing cathodic protection for a pipeline is disclosed by Allebach et al in U.S. Pat. No. 6,238,545. As the system includes a power source, an electric connection to the sacrificial anode is specified.

### OBJECT OF THE INVENTION

It is therefore one of the objects of the present invention to obviate the disadvantages of prior art methods of forming a continuous electrical connections of pipelines for cathodic protection, and to provide a pipe clamp or coupling which provides a secure, robust and inexpensive arrangement for making electrical contact with such pipeline.

It is a further object of the present invention to secure the arcuate strip bridging the gap formed at the open section of the clamping band in a pipe coupling and to prevent said strip from moving out of position.

Yet a further aim of the present invention is to secure in position one end of a rubber mat used as a flexible sleeve in a pipe clamp or coupling.

### SUMMARY OF THE INVENTION

The present invention achieves the above objects by providing, in a pipe clamp for sealing by means of a metal clamping band to surround the pipe or a pipe coupling for removably holding extremities of a pair of metallic pipes and a flexible inner sleeve disposed inside the clamping band; the improvement being the attachment of the inner sleeve to the clamping band by means of metallic fasteners, the metallic fasteners being arranged to contact the metallic pipes when the assembly is tightened, to form a continuous electrical connection of the pipes.

In a preferred embodiment of the present invention there is provided in a pipe clamp for sealing damaged pipes or a coupling for removably holding extremities of a pair of metallic pipes and a flexible inner sleeve disposed inside the clamping band, and being further provided with an arcuate strip bridging the gap formed at the open section of the clamping band, the improvement being the attachment of the arcuate strip to the clamping band by any suitable means.

In a most preferred embodiment of the present invention there is provided a pipe clamp or coupling wherein the metallic fasteners retaining the arcuate strip are arranged to contact the metallic pipes when the assembly is tightened, to form a continuous electrical connection of the pipes.

It will thus be realized that the present invention serves to maintain the arcuate strip in its correct position, to compress the rubber inner sleeve also where there is a gap in the band clamp.

While the subject of the present invention is referred to as a pipe coupling, the same is also used for temporary repair of a leaking pipeline. Thus the words pipe coupling are intended to include use of the coupling for purposes of sealing a leak in a damaged pipeline.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a perspective view of a preferred embodiment of the pipe clamp according to the invention;

FIG. 2 is a perspective detail view of an embodiment provided with an arcuate strip; and

FIG. 3 is a perspective view of an embodiment of the clamp having a second mode of an electric terminal.

### FULL DESCRIPTION OF THE INVENTION

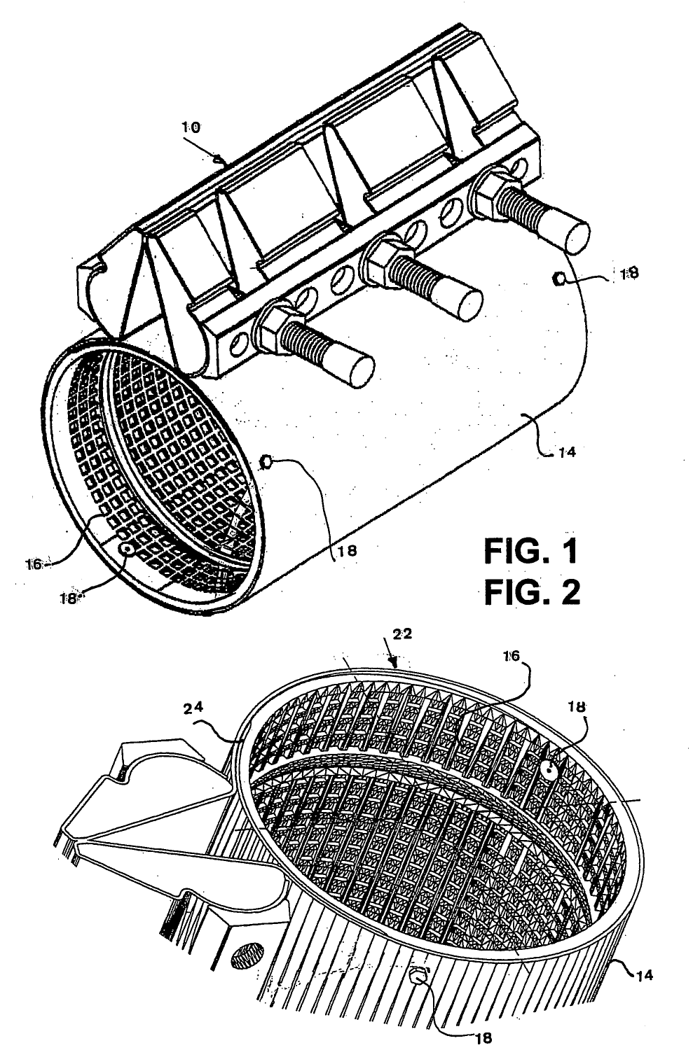

There is seen in FIG. 1 a pipe clamp or coupling 10 for sealing or for removably holding extremities of a pair of metallic pipes 12. The clamp force is provided by a metal clamping band 14 surrounding the pipe 12. A flexible inner sleeve 16 is disposed between the pipe 12 and the clamping band 14.

The inner sleeve 16 is attached to the clamping band 14 by means of a first plurality of metallic fasteners 18. The fasteners 18 are arranged to contact and press against the metallic pipe 12 when the band 14 is tightened, consequently forming a continuous electrical connection of the pipes. In one of our co-pending applications the sleeve is formed of a rolled-up mat. The fasteners 18 then serve to retain of one of the ends of the mat in the correct position relative to the clamping band 14.

With reference to the rest of the figures, similar reference numerals have been used to identify similar parts.

Referring now to FIG. 2, there is again seen a pipe clamp or coupling 22. As in the previous figure a flexible inner sleeve 16 is disposed inside the clamping band 14. An arcuate strip 24 bridges the gap formed at the open section of the clamping band 14. The strip 24 applies pressure to that part of the flexible sleeve 16 which is not contacted by the clamping band 14.

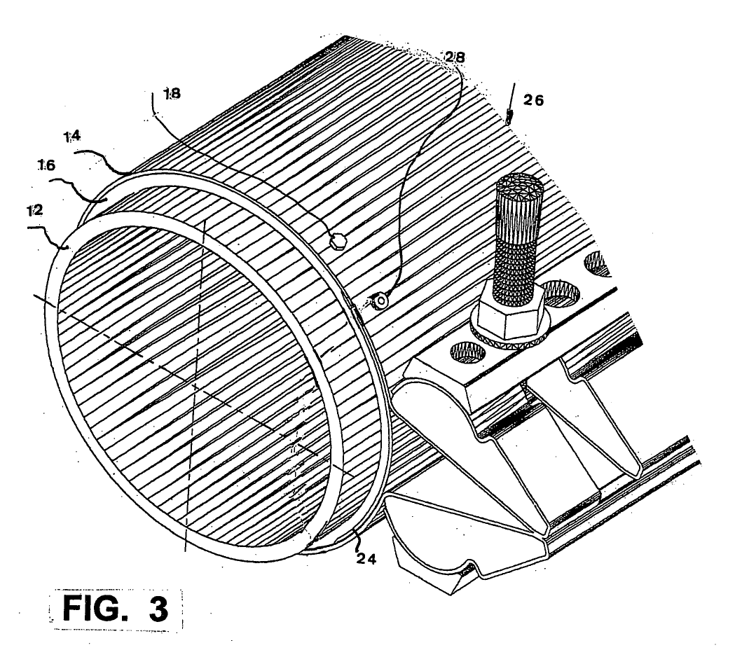

FIG. 3 illustrates an embodiment of the pipe clamp 26 similar to that seen in FIG. 2 wherein a second plurality of metallic fasteners 28 retain the arcuate strip 24 in its correct position. It is within the scope of the invention to connect said strip 24 by means such as rivets, bolts welding and the like.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. In a pipe sealing clamp or coupling for removably holding extremities of a pair of metallic pipes in axial sealing relationship by means of a metal clamping band to surround said pipes and a flexible inner sleeve disposed inside said clamping band; the improvement being the attachment of said inner sleeve to said clamping band by means of metallic fasteners, said metallic fasteners being arranged to contact said metallic pipes when said assembly is tightened, to form a continuous electrical connection of the pipes.

2. In a pipe sealing clamp or coupling for removably holding extremities of a pair of metallic pipes in axial sealing relationship by means of a metal clamping band to surround said pipes and a flexible inner sleeve disposed inside said clamping band, and being further provided with an arcuate strip bridging the gap formed at the open section of said clamping band, the improvement being the attachment of said arcuate strip to said clamping band by any suitable means.

3. The pipe clamp or coupling as claimed in claims 1 and 2 wherein said metallic fasteners are rivets.

4. The pipe clamp or coupling as claimed in claims 1 and 2 wherein said metalic fasteners are bolts or welded.
